(19) United States
(12) Patent Application Publication
(10) Pub. No.: US 2014/0258382 A1
(43) Pub. Date: Sep. 11, 2014

(54) APPLICATION CONGESTION CONTROL

(71) Applicant: TIBCO Software Inc., Palo Alto, CA (US)

(72) Inventors: Anirudh Tomer, Pune (IN); Mark Wiley, San Jose, CA (US); Suresh Subramani, San Jose, CA (US)

(73) Assignee: TIBCO Software Inc., Palo Alto, CA (US)

(21) Appl. No.: 14/180,210

(22) Filed: Feb. 13, 2014

Related U.S. Application Data
(60) Provisional application No. 61/764,949, filed on Feb. 14, 2013.

(51) Int. Cl. H04L 12/24

(52) U.S. Cl. CPC H04L 41/145
USPC 709/203

(57) ABSTRACT

Controlling client side application congestion at least in part by using one or more heuristics to predict at a data producer node, such as a server, how much time an application at a data consumer node, such as a client, will require to process a unit of data is disclosed. In various embodiments, a predicted client side processing time associated with a unit of data to be sent to a client is determined. The predicted client side processing time associated with the unit of data is used to determine a time to send a data transmission to the client.

### CROSS REFERENCE TO OTHER APPLICATIONS

This application claims priority to U.S. Provisional Patent Application No. 61/764,949 entitled APPLICATION CONGESTION CONTROL filed Feb. 14, 2013 which is incorporated herein by reference for all purposes.

### BACKGROUND OF THE INVENTION

Server applications may employ various techniques to stream data to clients. One approach is to stream data continuously or as soon as it is ready to be sent. This approach can work very well if data is sent in very small chunks which can be quickly processed by the client; however, for applications in which data is more complex, more processing is required by the client. Such additional processing paired with a continuous stream of data becomes problematic and can lead to poor client responsiveness as the client must parse high-frequency, complex data.

Some attempts to address the problem of over-burdening the client have been made. The most common techniques utilize various data burst strategies to keep data flowing smoothly. Periodic burst, for example, involves streaming data at constant time intervals in order to avoid causing congestion. This approach, however, cannot provide continuous data streaming in the event that the communication channel and client can handle it, and congestion can still occur because the interval at which data is streamed is arbitrary and does not necessarily take into account current communication channel conditions or client computational capacity.

An alternative to sending data in periodic bursts is to buffer updates at the server until a certain data-based threshold is met (until 100 kB of data is ready or five updates have been accumulated for example). This technique has the advantage of saving communication channel bandwidth as there is less overhead information when sending a cumulative update as opposed to many smaller updates. A reduced number of updates also results in some computational gains as fewer communication channel specific computations need to be performed. While this technique has its advantages, it too is susceptible to client inundation. More update data per update means a client will need more time to process the additional information. Again, if data arrives faster than it can be processed, client responsiveness can deteriorate.

### BRIEF DESCRIPTION OF THE DRAWINGS

Various embodiments of the invention are disclosed in the following detailed description and the accompanying drawings.

FIG. 1 is a block diagram illustrating an example of an environment in which adaptive burst streaming as disclosed herein may be performed.

FIG. 2 is a block diagram illustrating an embodiment of a client system configured to use a single processing thread to perform application related processing, including the receipt and processing of data streamed by a remote server.

FIG. 3 is a block diagram illustrating an embodiment of an application running on a client system configured to use a single processing thread to perform application related processing, including the receipt and processing of data streamed by a remote server.

FIG. 4 is a block diagram illustrating an embodiment of an application running on a client system configured to use a single processing thread to perform application related processing, including by cooperating with a remote server to use an adaptive burst approach to stream data to the client system.

FIG. 5 is a block diagram illustrating an embodiment of a server configured to use an adaptive burst approach to stream data to a client system.

FIG. 6 is a block diagram illustrating an embodiment of a client processing time prediction engine.

FIG. 7 is a flow chart illustrating an embodiment of a process to gather and report client processing time observations.

FIG. 8 is a flow chart illustrating an embodiment of a process to build and maintain a model based on client processing time observations.

FIG. 9 is a flow chart illustrating an embodiment of a process to stream data to a remote client.

FIG. 10 is a flow chart illustrating an embodiment of a process to provide client processing time predictions.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An “adaptive burst” approach to data streaming is disclosed. In various embodiments, machine learning techniques are applied to various real-time metrics and heuristic information in order to send data in bursts which do not overwhelm client applications and yet can still provide a continuous supply of data if the client and communication channel can accommodate it.

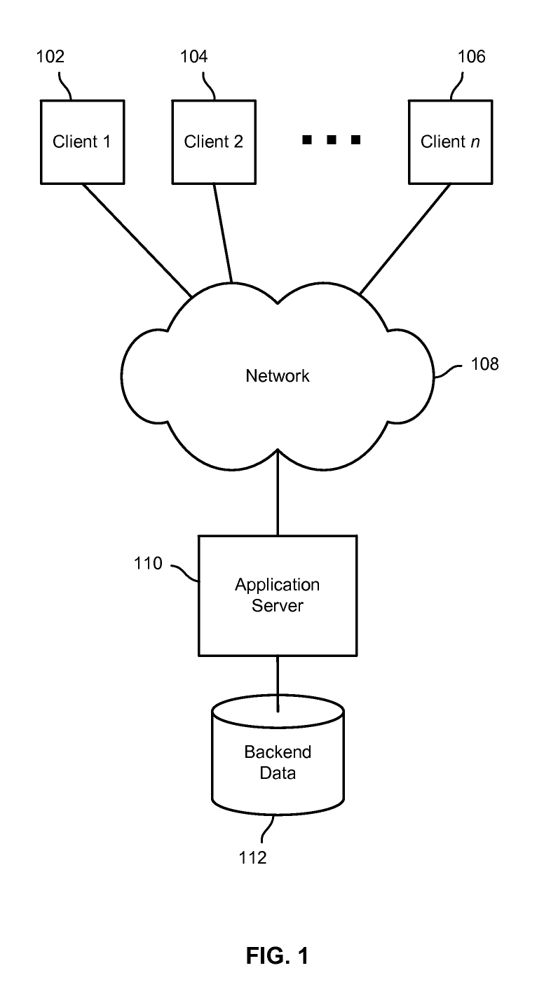

FIG. 1 is a block diagram illustrating an example of an environment in which adaptive burst streaming as disclosed herein may be performed. In the example shown, a plurality of clients, represented in FIG. 1 by clients 102, 104, and 106; connect via network 108 (e.g., the Internet) to an application server 110 having an associated backend data store 112, e.g., a database. In some embodiments, a browser, client application, or other software running on clients such as 102, 104, and 106 communicates with application server 110, for example to provide and/or obtain data and/or to invoke application-related processing and/or other services via requests sent from the respective client systems 102, 104, and/or 106 to server 110. Server 110 may retrieve data from backend data store 112, invoke external services not shown, perform transformations or other processing of request data received from the client, etc. to provide in response to each respective requesting client a stream of application or other response data. Application code on the client side, e.g., JavaScript or other code executing in a browser or other runtime environment running on the client system, may be responsible for receiving and processing data streamed by server 110. In some cases, other application code running on the same client system may be placing tasks in a same, single threaded processing queue as the code configured to handle data streamed by the server. For example, other tasks relating to displaying and updating a user interface page displayed at the client, and/or tasks generated to respond to user input, such as input made via a user interface displayed at the device, may be placed in the same queue, served by the same single thread, as server response data processing tasks.

In various embodiments, techniques disclosed herein are used in connection with systems that involve a potentially high-output data service and one or many data consuming clients, such as clients 102, 104, and 106.

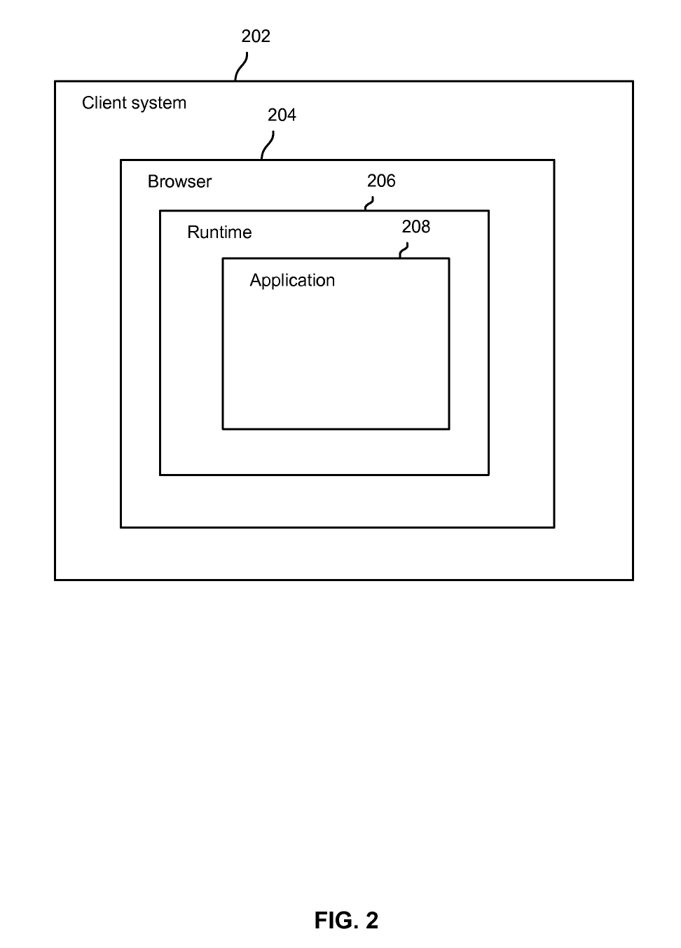

FIG. 2 is a block diagram illustrating an embodiment of a client system configured to use a single processing thread to perform application related processing, including the receipt and processing of data streamed by a remote server. In the example shown, a client system 202 has a browser software 204 executing on top of an operating system (not shown). The browser 204 provides a runtime environment 206 in which application code 208 executes. An example of application code 208 executing in runtime environment 206 includes, without limitation, code executing in a Java Virtual Machine.

In various embodiments, techniques disclosed herein are used in connection with systems where clients push and pop asynchronous tasks from a first-come-first-served, single-threaded processing queue. For example, graphical user interface (GUI) platforms like Swing, AWT, and web browsers use a single event queue to store and process GUI rendering, network communication, and user action tasks. Tasks on the queue may be processed in a first-come-first-served basis, or serially in an order other than first-come-first-serve, and under normal circumstances this approach works without issue. If, however, the task queue becomes overwhelmed (i.e. by an abundance of network data processing tasks), the time it takes to process basic UI rendering and interaction tasks will increase dramatically, resulting in an unresponsive user interface. In other words, as the number of pending unprocessed events increases, user actions face starvation because they must wait for all previously queued tasks before getting processed.

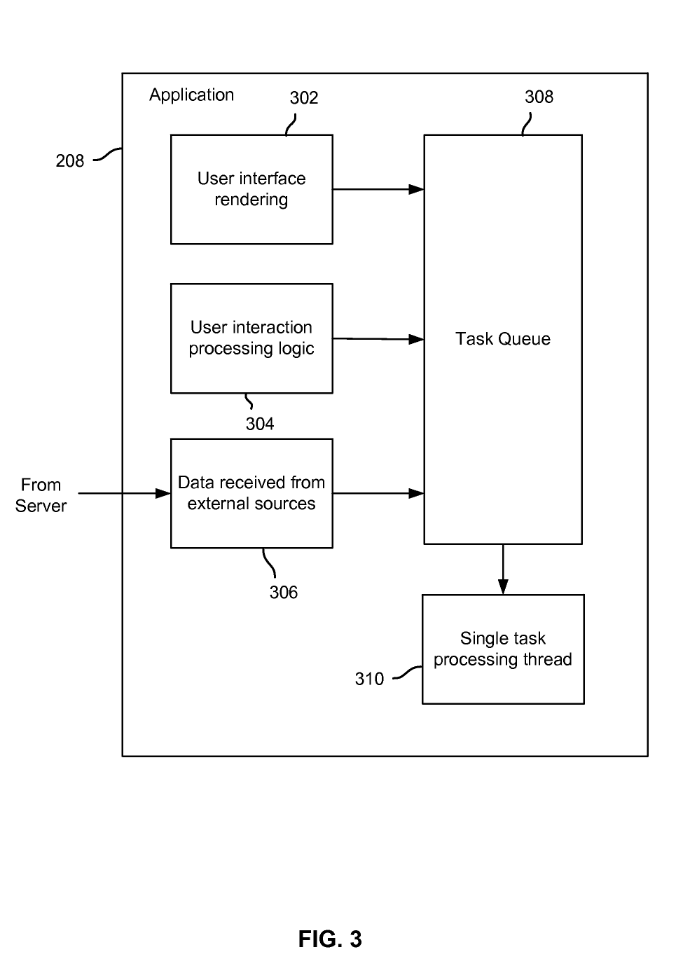

FIG. 3 is a block diagram illustrating an embodiment of an application running on a client system configured to use a single processing thread to perform application related processing, including the receipt and processing of data streamed by a remote server. In the example shown, application 208 includes a user interface rendering code 302, user interaction processing logic 304, and a server response handling code 306 that receives data streamed from a remote server. In the example shown, each of the code portions 302, 304, and 306 places processing tasks in a shared task queue 308 associated with a single processing thread 310 that is available to perform tasks in task queue 308. The architecture shown in FIG. 3 is typical, for example, of application code executing a browser or browser-provided environment. As a result, if the server were to overwhelm the client with too much data sent too quickly, associated processing tasks place in queue 308 by code 306 may crowd out user interface rendering or other tasks, resulting in delays that may be perceptible to a user of the client system on which application 208 is running.

In various embodiments, machine learning strategies are used to optimize data streaming to avoid such impacts on client system performance. Real-time measurements and heuristic information are used in various embodiments to predict the amount of time that will be required by a data consumer to process a particular unit of data. Using this information, the data may be withheld from the stream until the calculated amount of time delay has passed. As a result, the consumer does not become backlogged with data processing tasks, and tasks critical to the maintenance of a responsive client continue to be executed in a timely fashion.

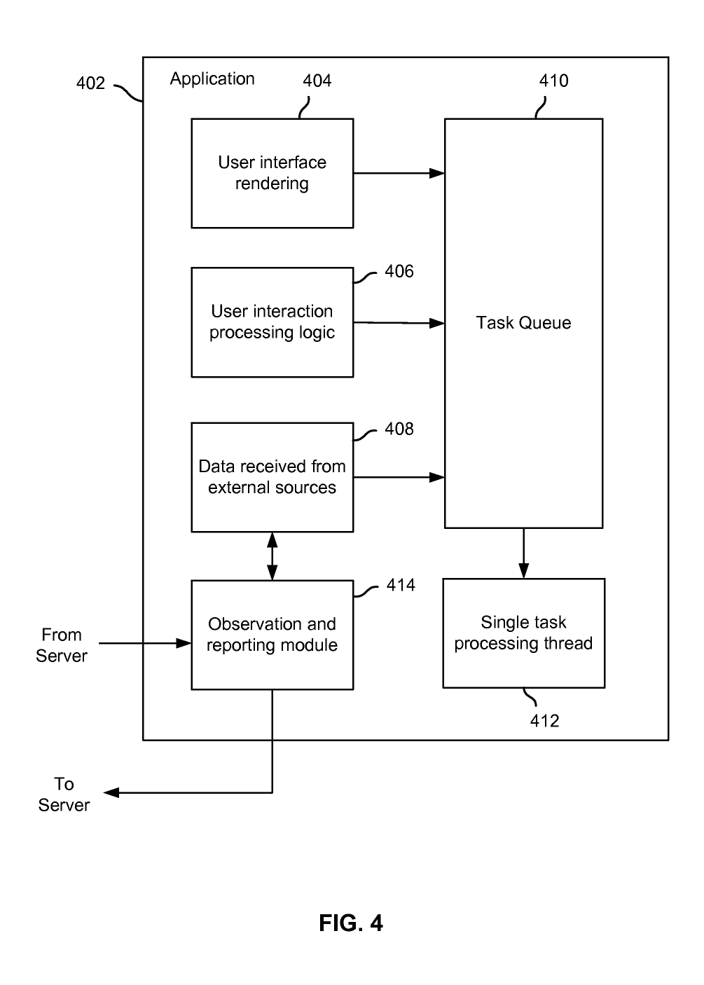

FIG. 4 is a block diagram illustrating an embodiment of an application running on a client system configured to use a single processing thread to perform application related processing, including by cooperating with a remote server to use an adaptive burst approach to stream data to the client system. In the example shown, similar to the application 208 of FIG. 3, the application 402 of FIG. 4 includes a user interface rendering code 404, a user interaction processing logic 406, and a server response processing code 408, each of which places processing tasks in a shared task queue 410 served by a single processing thread 412. However, in the example shown in FIG. 4, a client processing time observation and reporting module 414 is included. In the example shown, data stream by the server is received first at observation and reporting module 414. For at least certain data received from the server, the observation and reporting module observes how much time the client system, e.g., the single processing thread 412, takes to process the data and reports the observed client side processing time back to the server. For example, a particular unit of data streamed by the server may be tagged or otherwise identified as data the client side processing time of which is to be observed and reported. The observation and reporting module 414 may observe a start and stop time of when the single task processing thread 412 began and completed processing associated with the task, respectively, and report the resulting observations (or, in some embodiments, a processing time computed based on the observations) back to the server. In some embodiments, the observation and reporting module 414 includes code configured to report observations back to the server by piggy backing data on a subsequent request or other communication by application 402 back to the server, for example by placing the observation data in a header or other structure associated with such a subsequent communication. In various embodiments, the observation and reporting module 414 comprises application code downloaded from the server in connection with other portions of application code 402 being downloaded, e.g., in response to a request made using a browser.

In various embodiments, a process of predicting the amount of time to delay outgoing data updates starts by recording the amount of time a client takes to process an initial set of updates. In various embodiments, processing time is the amount of time that passes while a client processes an update. In some embodiments, the processing time does not include any time the update waits to be processed whether on a task queue or as a result of some other scheduling mechanism. In some other embodiments, the time an update waits to be processed may be included in the predicted (or observed) client processing time. The client consumer reports this information back to the producing server. In a browser-executed client side application or other code, for example, JavaScript or other code comprising or otherwise associated with the application may be included in code downloaded to the client for execution by the browser, and this code may be configured to perform the client-side update processing time observation and reporting described above.

At the server side, this feedback (i.e., the time the client took to process the initial update(s)) is coordinated with applicable heuristic information (described in the next section) in order to calculate the amount of time to delay (if needed) the next update going to the client. In some embodiments, client compute time feedback is sent only until the server has established a steady delay prediction equation, at which point the client is signaled and no longer sends compute times. If the prediction equation ever reaches a prediction breakpoint, the server can signal the client to restart computation time reporting.

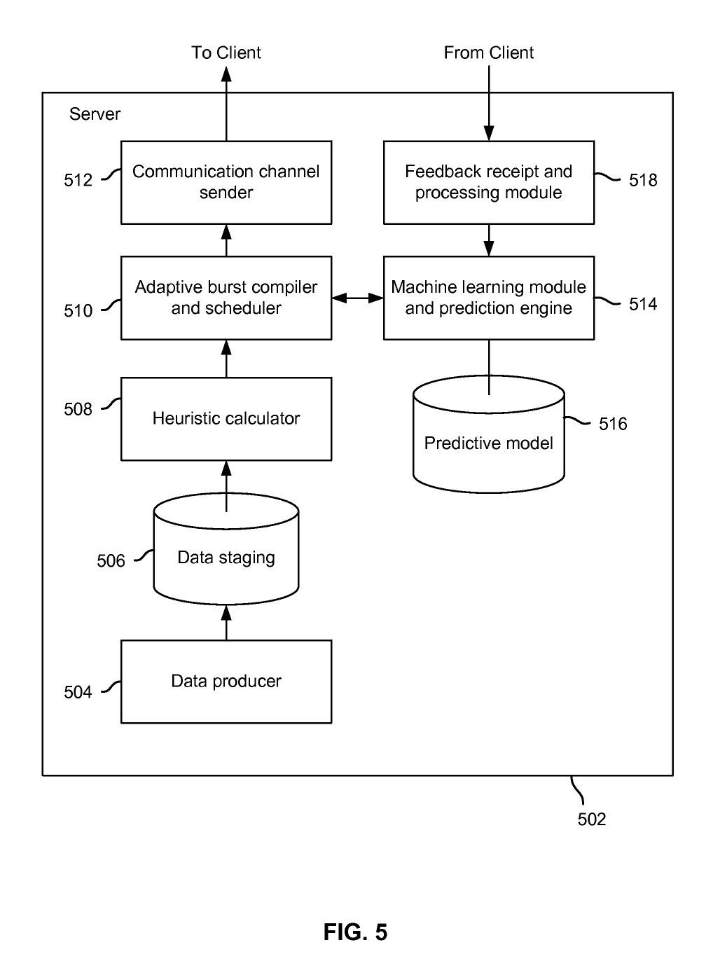

FIG. 5 is a block diagram illustrating an embodiment of a server configured to use an adaptive burst approach to stream data to a client system. In the example shown, server 502 includes a data producer module 504, e.g., server side code that generates units of data to be sent to one or more client systems, e.g., in response to requests sent previously from such clients to server 502. Examples include, without limitation, retrieving from a local or remote data source data requested by a client, processing data received from and/or otherwise associated with a client to produce a result to be sent to the client, etc. In the example shown, data produced by data producer module 504 is staged in a data staging area 506. A heuristic calculator 508 computes one or more heuristics for each unit of data in data staging area 506. For example, data size, complexity (e.g., number of levels and/or nodes in XML or other hierarchical data), and/or other heuristics may be calculated. The computed heuristic values are provided to an adaptive burst compiler and scheduler 510. The adaptive burst compiler and scheduler compiles response data into data sets for efficient transmission to a client system using a communication channel sender 512 configured to transmit data sets via a network, e.g., using a network interface card or other communication interface hardware and/or software. In the example shown, the adaptive burst compiler and scheduler 510 provides heuristics computed by heuristic calculator 508 to a machine learning module and prediction engine 514. The machine learning module and prediction engine 514 uses a predictive model built and updated based on client side processing time observations received from the respective clients via a feedback receipt and processing module 518. In various embodiments, machine learning module and prediction engine 514 applies a statistical regression algorithm to observed client side processing time observations to build and update predictive model 516. In various embodiments, predictive model 516 may be used in connection with observed environmental and/or external conditions (e.g., client computer resource usage, network congestion, etc.) to provide a client computation time prediction for a unit of data.

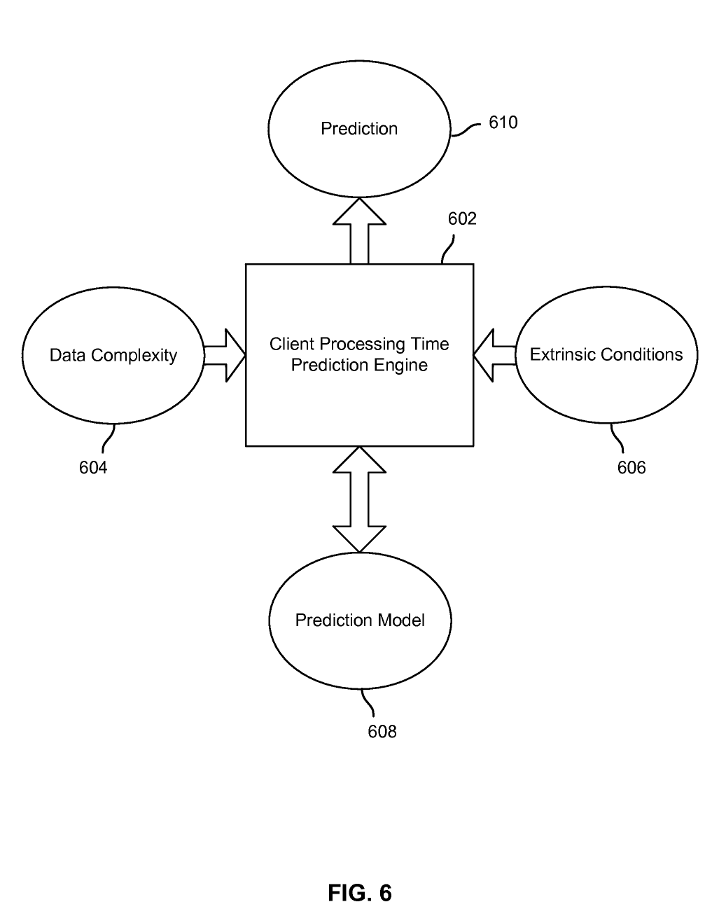

FIG. 6 is a block diagram illustrating an embodiment of a client processing time prediction engine. In the example shown, client processing time prediction engine 602 receives data complexity and/or other heuristic values 604 computed for a data unit and extrinsic (i.e., not based on the data unit with which the received heuristic values 604 are associated) condition data 606, e.g., client resource usage, network transmission delay, etc., and uses a predictive model 608 to determine for the data unit a predicted amount of time it is expected the client will take to process the data unit at the client side, based on the received heuristics 604 and under the prevailing conditions 606. The resulting prediction 610 is returned and used, for example, by a scheduling algorithm and/or module to determine an amount of time to wait to send the data unit, or in some embodiments an amount of anticipated client side processing time to be associated in some other way with the data unit, for example in connection with maintaining a model or other virtual view of an application task processing queue at the client side.

In various embodiments, dynamic application task congestion control includes gathering and analyzing heuristic information. Data complexity, network delay, and current client processing capability are examples of heuristics that may be used in various embodiments. The choice of heuristic parameters is left to the application developer in various embodiments, as different parameters may apply to different applications and deployment environments. In some embodiments, an interface is provided for applications to supply the necessary parameters to compute the appropriate amount of time to delay outgoing data.

In various embodiments, the data's complexity is considered in predicting time to process data. In some embodiments, data complexity is integrated as a heuristic parameter by counting the number of nodes and attributes of a particular XML or JSON file or the size of a binary file. In some embodiments, data complexity is calculated at least in part by assigning weights to the nodes in the XML or JSON file according to each node's hierarchal position in the data, then summing up the number of nodes multiplied by their respective weights. One could further increase sophistication by catering analysis to how the consumer will process the data. For example, if a client application performs advanced string dissection and manipulation, the number and length of strings contained in outgoing data may weigh more heavily on the evaluation of data complexity than the presence of floating point numbers. Alternatively, if it is known that an update will result in updating the client's UI (i.e. a redraw of the UI will be required), that update will result in a higher degree of data complexity than one that simply updates a client's data model.

When attempting to optimize the amount of data being sent to a client application, the amount of network delay encountered during transmission is taken into consideration in various embodiments. In some embodiments, a network delay parameter is provided as an input to the transmission delay computation.

If no network delay parameter is provided, in some embodiments it is assumed that no network delay, or in some embodiments constant delay, as in the case of an intranet, is encountered. In environments where network delay remains constant, the application will incur no adverse effects to client responsiveness and idle time. Update data will be sent at a frequency solely determined by the other heuristics provided to compute the transmission delay as well as the client compute times provided by the client. Since each data update sent to the client will incur a constant network delay, the frequency at which the client receives updates will be the same as the frequency at which the server sent them. In this way, techniques disclosed herein are agnostic of network delay so long as the network delay between client and server remains constant.

In real-world scenarios, however, network delay is not constant and may skew the effective frequency of data arrival at the client. To compensate, one can provide an additional parameter to the transmission delay calculation. For example, if server-to-client ping time is measured before each data transmission, that measured network delay time can be factored into transmission delay computations and will help in predicting a more optimal data transmission delay.

The amount of time a client will take to process a data update is directly proportional to the computational resources it has available to it at the time of receipt. A client's computational load is thus potentially valuable information to have when trying to predict the amount of time a client will require to process a data update.

Since such a metric can only be measured at the client, its valuation must be sent to the server. In various embodiments, client computation load data is sent to the server via a separate stream message. In some embodiments, client computation load data is piggy-backed onto the computation time parameter message.

In various embodiments, client compute time measurements and heuristic parameters are used in conjunction with a statistical regression analysis algorithm to predict the amount of time the server should separate outgoing data updates. For example, in various embodiments a linear least squares or other statistical regression algorithm may be used to fit a mathematical model to a given set of observed client processing time data in order to calculate appropriate update delay times. While in the foregoing example a linear least squares statistical regression algorithm used to fit a mathematical model to a given data set in order to calculate appropriate update delay times is described in some detail above, in various embodiments one or more other statistical regression algorithms and/or other techniques may be used to fit a mathematical model to a given data set in order to calculate appropriate update delay times.

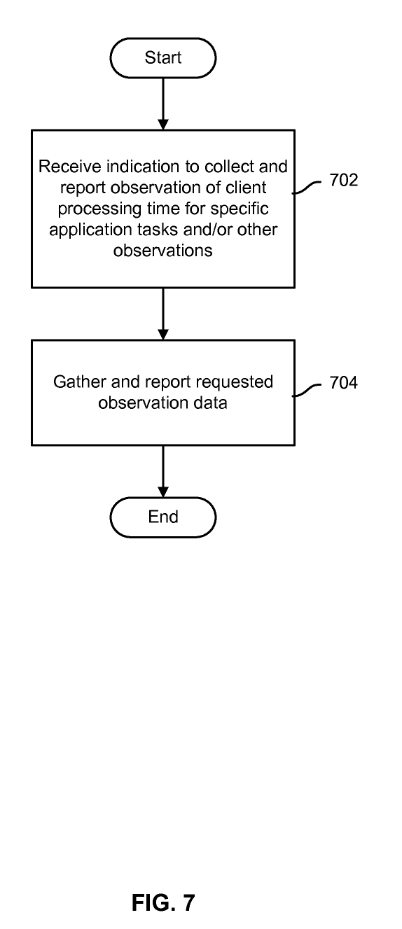

FIG. 7 is a flow chart illustrating an embodiment of a process to gather and report client processing time observations. In various embodiments, the process of FIG. 7 may be implemented by a client side observation and reporting module, such as module 414 of FIG. 4. In the example shown, an indication to collect and report a client processing time observation is received (702). For example, a response or other data unit received from the server may include a data value that indicates that a client processing time observation is to be made with respect to that task. Alternatively, a list of tasks to be observed may be received. The indicated client processing time observation(s) is/are made and reported (704). For example, client processing start and end times for observed tasks may be reported, as described above.

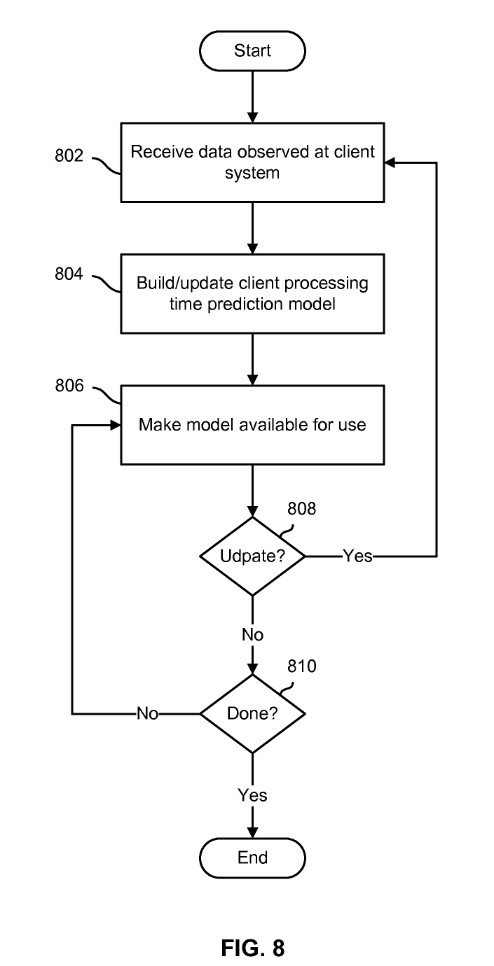

FIG. 8 is a flow chart illustrating an embodiment of a process to build and maintain a model based on client processing time observations. In various embodiments, the process of FIG. 8 may be implemented by a machine learning module, such as machine learning module and prediction engine 514 of FIG. 5. In the example shown, data observed at a client system is received (802). A client processing time model is built/updated based on the received observation(s) (804). For example, a statistical regression and/or other analysis may be performed and/or updated. The model may comprise one or more equations to be used to predict a client side processing time of a data unit, based on data complexity and/or other heuristics associated with the data unit. The resulting client processing time prediction model is made available (806), for example to be used to predict client processing time for data units to be sent to the client. If it is determined that an update to the model should be made (808), one or more further observations are obtained from the client and used to update the model (802, 804, 806). For example, if a data unit to be sent has a data complexity of other heuristic value falling in a range for which no or an insufficient number of observations have been made, the data unit may be sent to the client with an indication that the client side processing time for the unit should be observed and reported, and the resulting observation may be used to update the model. The process of FIG. 8 continues until done (810).

In some embodiments, the processing time prediction equation (model) may be updated continuously. If for the data available to be streamed fits in a bucket (e.g., range of observed/predicted processing times) which is already full then it is not considered a sample data and instead a computation time is predicted for it using the current prediction equation. Otherwise, it is considered as a sample, and the time taken at the client to process it is measured and used to update the model.

In some embodiments, a bootstrap equation (model) may be generated based on just a few initial observations at the client. Since the bootstrap equation is just based on a few samples available, for a subsequent data unit, e.g., a bigger sample than those on which the bootstrap equation is based, the bootstrap equation may predict a negative processing time in some cases. In some embodiments, the point after which the client processing time prediction curve's Y (time) value starts to decrease for corresponding X (data complexity or other heuristic) value; is considered a “prediction breakpoint.” The moment a data packet is available whose data complexity crosses the prediction breakpoint it is again considered as a probable sample and is added to the sample matrix so the prediction equation can be updated.

Thus the sample collection process keeps switching, in various embodiments, between learning and prediction based on currently available data samples. In some embodiments, a permanent prediction (non-learning) mode may be entered into, e.g., once it has been determined that a robust model capable of providing reliable predictions for a wide range of data unit complexity (and/or other attributes/heuristics) has been achieved.

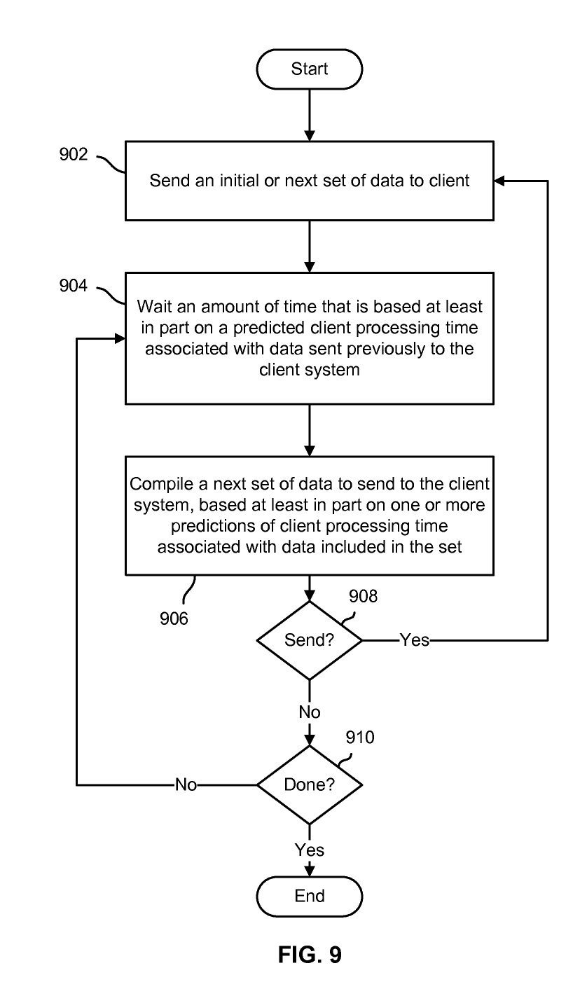

FIG. 9 is a flow chart illustrating an embodiment of a process to stream data to a remote client. In various embodiments, the process of FIG. 9 may be implemented by an adaptive burst scheduling module, such as adaptive burst compiler and scheduler 510 of FIG. 5. An initial (or next) set of data is sent to the client (902). For example, a set of data units previously compiled to be sent as one set to the client may be sent. An amount of time that is based at least in part on a predicted client side processing time associated with the set of data that has been sent is waited (904). For example, if the client is predicted, based on data complexity and/or other heuristics computed for the data that has been sent, to need 100 milliseconds to process the data in the set, further data is not sent for 100 milliseconds. A next set of data to be sent to the client system is compiled (906). The amount of data (e.g., number of data units) included in the set is determined at least in part by client side processing time predictions associated with data units included and/or considered to be included in the set (906). Once the time to send the next set of data is reached (908), the next set is sent, and a further iteration of steps 902, 904, and 906 is performed. The process of FIG. 9 continues until done (910), e.g., all data required to be sent to the client system has been sent.

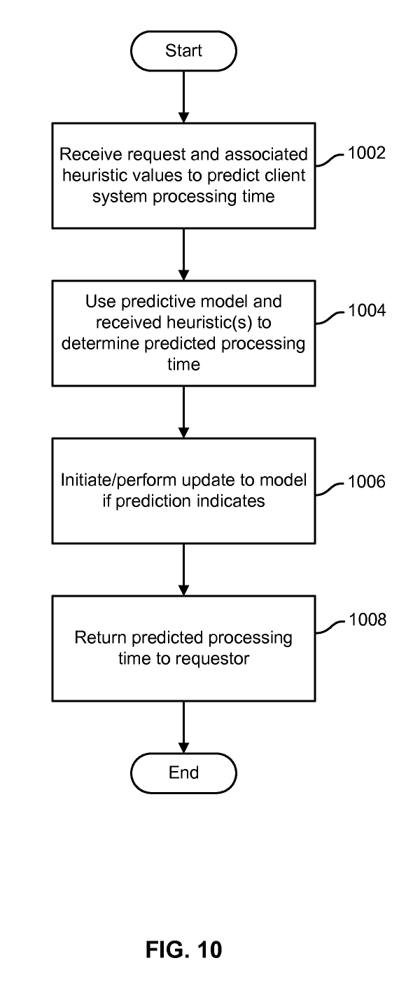

FIG. 10 is a flow chart illustrating an embodiment of a process to provide client processing time predictions. In various embodiments, the process of FIG. 10 may be implemented by a machine learning module and/or prediction engine, such as machine learning module and prediction engine 514 of FIG. 5 or prediction engine 602 of FIG. 6. In the example shown, a client side processing time prediction request, and associated heuristic values to be used to make the prediction, are received (1002). A predictive (e.g., statistical) model is used to determine a prediction based on the received heuristics (1004). If indicated based on the heuristics (e.g., data complexity not seen previously) and/or prediction (e.g., negative prediction, or predicted time lower than for less complex data seen previously), the model is updated (1006) in connection with the request. For example, the data unit that is the subject of the request may be used a further sample to update the model. A predicted client side processing time is returned to the requestor (1008).

Techniques to manage client congestion by regulating data transmission from the server have been disclosed. In various embodiments, a model of communication in which a consumer application provides regular feedback to producer applications (e.g., a server) has been disclosed, enabling the producer to build and utilize a heuristic-aided model to predict the amount of time the consumer will take to process a given data update. This predicted time is then used in various embodiments to scale the frequency at which the producer application sends updates to the consumer.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining at a server a predicted client side processing time associated with a unit of data to be sent to the client; and
using the predicted client side processing time to determine at the server a time to send a data transmission from the server to the client.

2. The method of claim 1, wherein determining a predicted client side processing time associated with the unit of data includes using a client side processing time model to determine the predicted client side processing time associated with the unit of data.

3. The method of claim 1, wherein a heuristic value computed based on the unit of data is used to determine the predicted client side processing time associated with the unit of data.

4. The method of claim 3, wherein the heuristic comprises a measure of data complexity for the unit of data.

5. The method of claim 4, wherein the measure of data complexity is computed based on one or more of the following: a size of the unit of data; a number of nodes comprising a hierarchical structure of the unit of data; a number of hierarchical levels in a hierarchical structure of the unit of data.

6. The method of claim 3, further comprising computing the heuristic value for the unit of data.

7. The method of claim 1, wherein the predicted client side processing time associated with the unit of data is determined at least in part based on an observed value extrinsic to the unit of data.

8. The method of claim 7, wherein the observed value extrinsic to the unit of data comprises one or more of the following: an observed level of utilization of resources at the client; and an observed network delay associated with transmissions between the server and the client.

9. The method of claim 1, further comprising creating at the server a model of client side processing times associated with processing at the client units of data received from the server.

10. The method of claim 9, wherein building the model includes observing at the client for each of one or more tasks to process units of data received from the server an associated client side processing time for that unit of data.

11. The method of claim 10, further comprising reporting the respective observed client side processing times to the server.

12. The method of claim 11, wherein said steps of observing and reporting are performed by an application code sent from the server to the client.

13. The method of claim 10, further comprising updating the model based on a subsequently observed client side processing time

14. The method of claim 11, wherein the subsequently observed client side processing time is observed at least in part in response to a determination at the server that an update to the model is indicated.

15. The method of claim 14, wherein the determination is based at least in part on a recognition that an anomalous predicted client side processing time has been predicted.

16. The method of claim 15, wherein the anomalous predicted client side processing time comprises one or both of a negative amount of time and a lesser amount of time than predicted for a more complex previous unit of data.

17. The method of claim 1, wherein using the predicted client side processing time to determine at the server a time to send a data transmission from the server to the client includes waiting for a transmission delay period determined based at least in part on the predicted client side processing time associated with the unit of data to send the data transmission.

18. The method of claim 17, wherein the data transmission comprises a set of one or more subsequent units of data to be sent to the client subsequent to the unit of data with respect to which the predicted client side processing time is associated.

19. A system, comprising:
a communication interface; and
a processor coupled to the communication interface and configured to:
determine a predicted client side processing time associated with a unit of data to be sent to a remote client; and
use the predicted client side processing time to determine at the server a time to send a data transmission to the client via the communication interface.

20. A computer program product embodied in a non-transitory computer readable storage medium and comprising computer instruction for:
determining at a server a predicted client side processing time associated with a unit of data to be sent to the client; and
using the predicted client side processing time to determine at the server a time to send a data transmission from the server to the client.
